(19) United States
(12) Patent Application Publication
(10) Pub. No.: US 2016/0342342 A1
(43) Pub. Date: Nov. 24, 2016

(54) INFORMATION PROCESSING DEVICE, INFORMATION PROCESSING SYSTEM, AND DATA ACCESS METHOD

(71) Applicant: NEC CORPORATION, Tokyo (JP)

(72) Inventors: Masaki KAN, Tokyo (JP); Jun SUZUKI, Tokyo (JP); Yuki HAYASHI, Tokyo (JP)

(73) Assignee: NEC Corporation, Minato-ku, Tokyo (JP)

(21) Appl. No.: 15/114,612

(22) PCT Filed: Feb. 4, 2015
(86) PCT No.: PCT/JP2015/000504

§ 371 Date: Jul. 27, 2016

(30) Foreign Application Priority Data
Feb. 5, 2014 (JP) 2014-020317

(51) Int. Cl. G06F 3/06; G06F 12/06; H04L 12/707; G06F 17/30; H04L 29/08

(52) U.S. Cl. CPC G06F 3/0611; G06F 3/0644; G06F 3/067; G06F 17/30345; G06F 17/30321; H04L 67/1097; H04L 45/22; G06F 12/0646; G06F 2212/1024; G06F 2212/154; G06F 2212/1041

(57) ABSTRACT

An information processing device is provided that improves the responsiveness of a storage system and a storage device that is accessed via a network. This information processing device includes: a means that calculates an address identifying an area, on the basis of an access identifier specifying data to be accessed, said area being in a storage device that stores a first data corresponding to the access identifier; and a means that obtains the first data included in second data being data for the area and read on the basis of the calculated address, on the basis of management information included in the second data, and executes a first data operation on the second data.

### TECHNICAL FIELD

The present invention relates to a technique for data access to a storage device and a storage system.

### BACKGROUND ART

Various techniques relating to control of data access to a storage device and a storage system are known.

There is, for example, a data store system (e.g. a database system, a file system, or a cache system) including a single or a plurality of calculators. In recent years, a distributed storage system has been frequently applied to such a system. The distributed storage system includes a plurality of general-purpose calculators connected via a network.

The distributed storage system stores data and provides data by using storage devices mounted on these calculators. The storage device is, for example, an HDD (Hard Disk Drive) or a main memory (e.g. DRAM: Dynamic Random Access Memory).

In the distributed storage system as described above, software or special hardware determines calculators with which data are provided and calculators which process data. Such an architecture is referred to as a Shared nothing Architecture.

A SAN (Storage Area Network) shares a storage device via a network such as FC (Fibre Channel) among a plurality of servers, for example. A data store system is realized by using, for example, a storage device shared by the SAN.

In the SAN, to realize a system by sharing data among a plurality of calculators, it is necessary to use software based on a Shared Everything Architecture. For example, in a file system, the software is a SAN file system or the like. Further, in a database system, the software is Oracle (registered trademark) RAC (Real Application Clusters) (registered trademark) or the like.

The Shared Everything Architecture is realized commonly by using FC or iSCSI (internet Small Computer System Interface). The FC and iSCSI cause a large communication delay. Therefore, a storage device having excellent response performance is less likely to be used, and therefore, a storage device such as an HDD having poor response performance is mainly used.

On the other hand, an HDD has excellent sequential access performance. Therefore, software for a database or the like sequentially writes only update information by using a method such as Write Ahead Log to cover the poor performance of the shared storage device.

In recent years, in a high-speed and general-purpose PCI-e (Peripheral Component Interconnect-Express) interface, a configuration in which a calculator is connected with a high-speed storage device such as an SSD (Solid State Drive) is used. Such a configuration makes it possible to access a high-speed storage device with a small delay. Therefore, such a configuration is used in an application such as a cache for a storage on the SAN.

Use of a technique for sharing a PCI-e device having such a configuration among a plurality of hosts by using ExpEther (registered trademark) makes it possible to realize a Shared Everything Architecture. Further, when such a configuration is employed, it is possible to realize storage sharing with a small delay, compared with the storage on the SAN.

PTL 1 discloses one example of a distributed system. In the distributed system of PTL 1, a record identified by an identifier is managed in a distributed manner by using a plurality of nodes connected via a network. The node includes a record storage means, an index providing means, and a record acquisition means.

The record storage means stores, as an aggregate, a plurality of records managed by the node for each optional range of an identifier.

The index providing means provides an index using an identifier included in a range of the aggregate for the aggregate.

The record acquisition means refers to the index for a record acquisition request and thereby acquires a record requested by the record acquisition request from the record storage means.

PTL 2 discloses one example of a storage system. The storage system of PTL 2 includes a plurality of hosts, a volume virtualization device, a plurality of storages, a management client, and a storage management server.

The hosts and the storages are connected via a communication network such as a LAN (Local Area Network) by sandwiching the volume virtualization device.

The volume virtualization device causes the host to recognize the plurality of storages as one virtual storage device.

The storage management server controls a volume disposition on the plurality of storages.

### CITATION LIST

### Patent Literature

PTL 1: Japanese Patent Application Laid-open Publication No. 2012-168781
PTL 2: Japanese Patent Application Laid-open Publication No. 2013-033515

### SUMMARY OF INVENTION

### Technical Problem

However, in the techniques described in the prior art documents, there is a problem that response performance of an external storage device has a value lower than a desired value.

The reason is that a storage device (the node of PTL 1 and the storage device of PTL 2) accessed via a network is affected by a delay due to command and response communications on the network, in addition to an access time to a storage device.

In other words, when a database or a KVS (Key Value Store) is realized by using the techniques disclosed in PTL 1 or PTL 2, to acquire desired data, a plurality of times of communications may be needed between an access source calculator, an external storage device, and an intermediate device. In other words, these storage devices accessed via a network have poor response performance due to an influence of a communication delay, compared with a storage means on a host (access source).

An object of the present invention is to provide an information processing device, an information processing system, a data access method, and a program therefor or a computer-readable non-transitory recording medium recording the program that solve the problem described above.

### Solution to Problem

An information processing device according to the one aspect of the present invention includes:

address resolution means that calculates an address identifying an area based on an access identifier specifying data to be accessed, the area being in a storage device that stores a first data corresponding to the access identifier; and

access execution means that acquires the first data included in second data based on management information included in the second data being in the area read based on the calculated address, and executes an operation of the first data on the second data.

A data access method according to the one aspect of the present invention causes a computer to:

calculate an address identifying an area based on an access identifier specifying data to be accessed, the area being in a storage device that stores a first data corresponding to the access identifier;

acquire the first data included in second data based on management information included in the second data being in the area read based on the calculated address; and

execute an operation of the first data on the second data.

A computer-readable non-transitory recording medium according to the one aspect of the present invention records a program that causes a computer to execute processing of:

calculating an address identifying an area based on an the access identifier specifying data to be accessed, the area being in a storage device that stores a first data corresponding to the access identifier,

acquiring the first data included in second data based on management information included in the second data being in the area read based on the calculated address; and

executing an operation of the first data on the second data.

A information processing system according to the one aspect of the present invention includes: an information processing device including address resolution means that calculates an address identifying an area based on the access identifier and access execution means that acquires the first data included in second data based on management information included in the second data being in the area read based on the calculated address, and executes an operation of the first data on the second data.

### Advantageous Effects of Invention

The present invention is effective in making improvements in response performance of a storage device and a storage system accessed via a network.

### BRIEF DESCRIPTION OF DRAWINGS

FIG. 1 is a block diagram illustrating a configuration of an information processing system according to a first exemplary embodiment of the present invention.

FIG. 2 is a block diagram illustrating internal configurations of a calculator and an external storage device in the first exemplary embodiment.

FIG. 3 is a block diagram illustrating a hardware configuration of a computer that realizes the calculator according to the first exemplary embodiment.

FIG. 4 is a flowchart illustrating operations of the calculator and the external storage device in the first exemplary embodiment.

FIG. 5 is a diagram illustrating one example of an address space of a data storage unit in the first exemplary embodiment.

FIG. 6 is a diagram illustrating one example of a structure of a page in the first exemplary embodiment.

FIG. 7 is a flowchart illustrating operations of the calculator and the external storage device in the first exemplary embodiment.

FIG. 8 is a block diagram illustrating a configuration of an information processing device according to a second exemplary embodiment of the present invention.

### DESCRIPTION OF EMBODIMENTS

Exemplary embodiments of the present invention will be described in detail with reference to the drawings. In the drawings and the exemplary embodiments described in DESCRIPTION, the same components are assigned with the same reference signs, and therefore, overlapping description will be omitted as appropriate.

### First Exemplary Embodiment

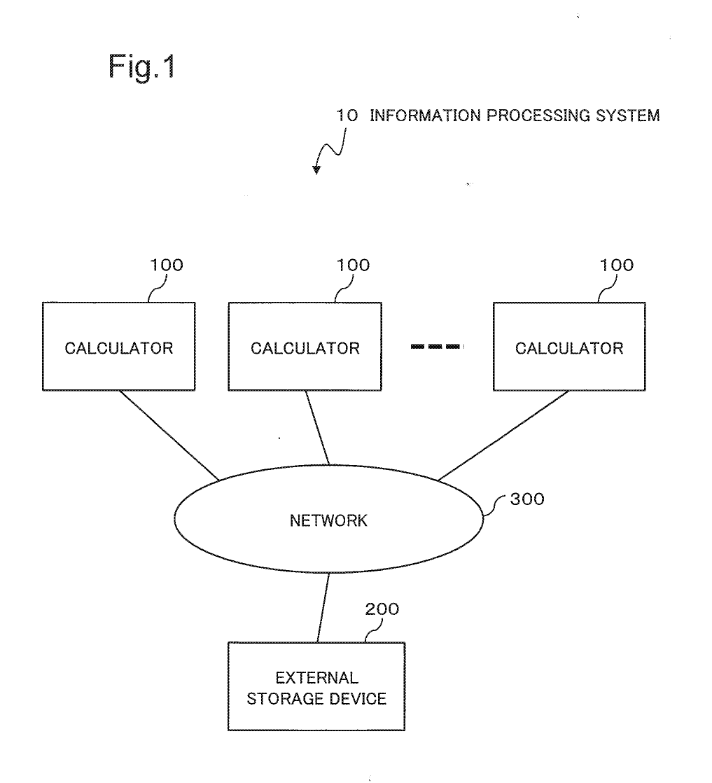

FIG. 1 is a block diagram illustrating one example of a configuration of an information processing system 10 according to a first exemplary embodiment of the present invention.

As illustrated in FIG. 1, the information processing system 10 according to the present exemplary embodiment includes a calculator (referred to also as an information processing device) 100, an external storage device 200, and a network 300. Regardless of the example illustrated in FIG. 1, a number of units of each of the calculator 100 and the external storage device 200 may be one or an optional plurality of units. Further, the external storage device 200 may be a storage system including an information processing device and a plurality of storage devices.

===Calculator 100===

The calculator 100 controls a data access to the external storage device 200 and thereby realizes a data store function. The calculator 100 is a computer device (referred to also as an information processing device) including an arithmetic device (e.g. a CPU (Central Processing Unit)), a storage unit, and an interface unit for connection to a network 300. The interface is, for example, a network card, a host bus adapter, a card including an ExpEther function, or the like.

===External Storage Device 200===

The external storage device 200 includes at least an interface means to be coupled with the calculator 100, a storage device, and a means that executes access processing to the storage device. The storage device is a flash memory, a DRAM, an MRAM (Magneto resistive Random Access Memory), an HDD, or the like.

The interface means controls Ethernet (a registered trademark), Fibre Channel, InfiniBand, or the like. When, for example, being coupled with the calculator 100 via ExpEther, the external storage device 200 is mounted with a storage device mounted with a card including an ExpEther function and a PCI-e interface.

The network 300 mutually connects the calculator 100 and the external storage device 200. The network 300 mediates data, a control message, and another message between the calculator 100 and the external storage device 200. The network 300 is realized using, for example, Ethernet, InfiniB and, TCP/IP (Transmission Control Protocol/Internet Protocol) using these, a high-order protocol such as RDMA (Remote Direct Memory Access), or the like. Further, the network 300 may be realized using Fibre Channel, FCoE (Fibre Channel over Ethernet), ExpEther, or the like. The network 300 may be realized, without limitation thereto, using an optional method.

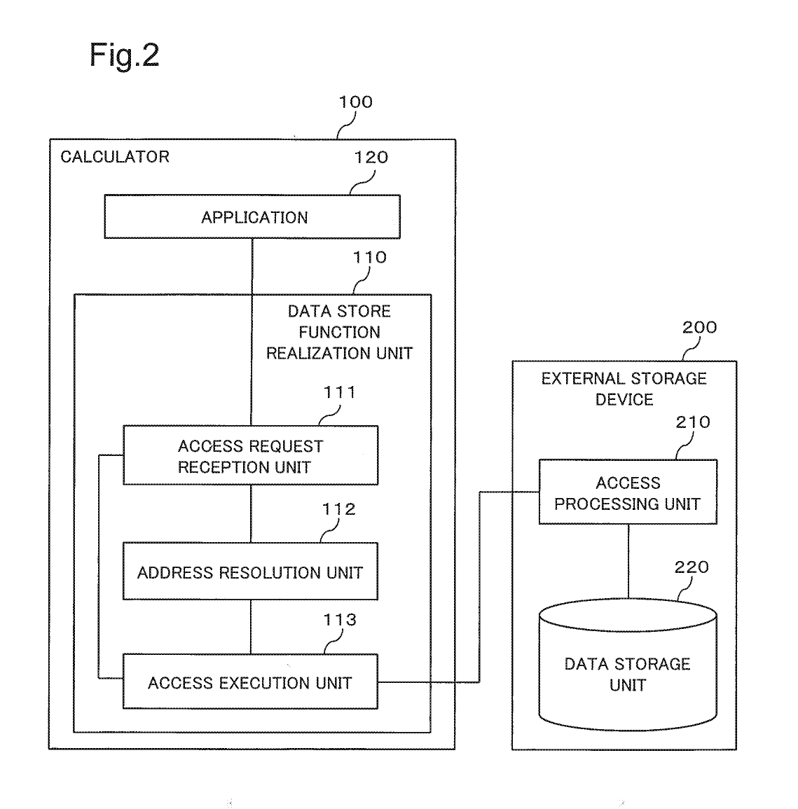

FIG. 2 is a block diagram illustrating internal configurations of the calculator 100 and the external storage device 200. Each component illustrated in FIG. 2 may be a circuit of a hardware unit or a component divided as a function unit of a computer device. Herein, the component illustrated in FIG. 2 will be described as a component divided as a function unit of a computer device.

In FIG. 2, the network 300 of the information processing system 10 illustrated in FIG. 1 is omitted. Further, FIG. 2 illustrates a configuration of the information processing system 10 including one calculator 100 and one external storage device 200.

===Internal Configuration of Calculator 100===

The calculator 100 includes a data store function realization unit 110 and an application 120.

The data store function realization unit 110 is software (data store software) that operates on an arithmetic device (a CPU 701 to be described later) to realize, for example, a database or a KVS (Key Value Store).

The application 120 is optional software using a data store. The application 120 may operate on a calculator other than the calculator 100 where the data store function realization unit 110 operates. The data store is realized by the data store function realization unit 110.

The data store function realization unit 110 includes an access request reception unit 111, an address resolution unit 112, and an access execution unit 113.

===Access Request Reception Unit 111===

The access request reception unit 111 receives a data access request command from the application 120. The access request reception unit 111 may be included as a part of an address resolution unit 112.

The data access request command differs depending on a function of data store software (i.e. a function of the data store provided by the data store function realization unit 110). When the data store is, for example, a database, the data access request command is a data operation command as specified by SQL (Structured Query Language). Further, when the data store is KVS, the data access request command is a processing command for acquiring or registering/updating a value corresponding to a Key.

===Address Resolution Unit 112===

The address resolution unit 112 interprets a data access request command received by the access request reception unit 111 and calculates an address for identifying a page (referred to also as an area) that stores data (first data) corresponding to the data access request command. The page is a partial area on a data storage unit 220 of the external storage device 200. The address resolution unit 112 calculates the address on the basis of an access identifier. The access identifier is information that identifies the first data in a function of the data store provided by the data store function realization unit 110. The address resolution unit 112 acquires the access identifier by interpreting the data access request command.

The “address for identifying the page” may be a physical address of the data storage unit 220 (to be described later) of the external storage device 200. Further, the “address for identifying the page” may be a logical address convertible to a physical address of the data storage unit 220 (to be described later) in an access processing unit 210 (to be described later) of the external storage device 200. Details of operations for calculating the “address for identifying the page” will be described later.

===Access Execution Unit 113===

The access execution unit 113 issues a data access request (e.g. a read request or a Write request) to the address calculated by the address resolution unit 112.

In other words, the access execution unit 113 specifies the address calculated by the address resolution unit 112 and issues a request (read request) for reading data (second data) of the page and a request (Write request) for writing data on the page.

Further, the access execution unit 113 acquires the first data included in the read second data, on the basis of management information included in the read second data. Further, the access execution unit 113 executes operations (addition, deletion, and update) of the first data for the read second data, on the basis of the management information included in the read second data. Details of the management information will be described later.

===Internal Configuration of External Storage Device 200===

The external storage device 200 includes the access processing unit 210 and the data storage unit 220.

===Access Processing Unit 210===

The access processing unit 210 receives a data access request from the access execution unit 113 of the calculator 100, acquires or operates data stored on the data storage unit 220 on the basis of an address included in the data access request, and responds to the calculator 100.

Further, the access processing unit 210 includes a function for control or the like based on storage medium characteristics of the data storage unit 220. The access processing unit 210 is realized commonly as a logic on some type of integrated circuit or FPGA (Field Programmable Gate Array). Specifically, the access processing unit 210 is a controller of a flash memory, a DRAM controller, or the like.

===Data Storage Unit 220===

The data storage unit 220 is an actual storage medium and includes a flash memory, a DRAM, an HDD, or a combination thereof.

The data storage unit 220 stores second data including first data corresponding to an access identifier on a page identified by an address corresponding to the access identifier.

The above is description on the components of the respective function units of the calculator 100 and the external storage device 200.

Next, components as hardware units of the calculator 100 will be described.

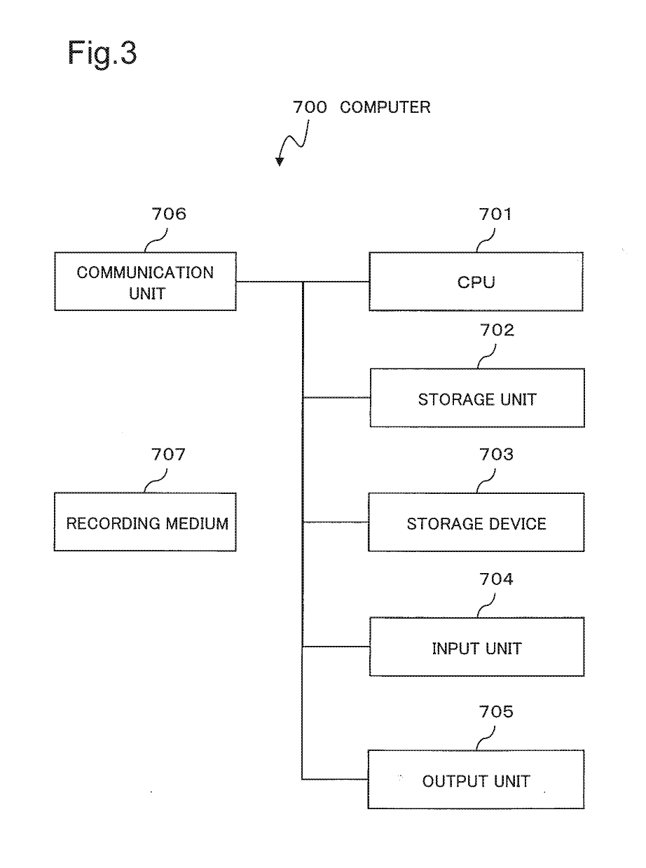

FIG. 3 is a diagram illustrating a hardware configuration of a computer 700 that realizes the calculator 100 in the present exemplary embodiment.

As illustrated in FIG. 3, the computer 700 includes a CPU (referred to also as a processor) 701, a storage unit 702, a storage device 703, an input unit 704, an output unit 705, and a communication unit 706. Further, the computer 700 includes a recording medium (or a storage medium) 707 supplied from the outside. The recording medium 707 is, for example, a non-volatile recording medium (non-transitory recording medium) that non-transitorily stores information. Further, the recording medium 707 may be a transitory recording medium that holds information as a signal.

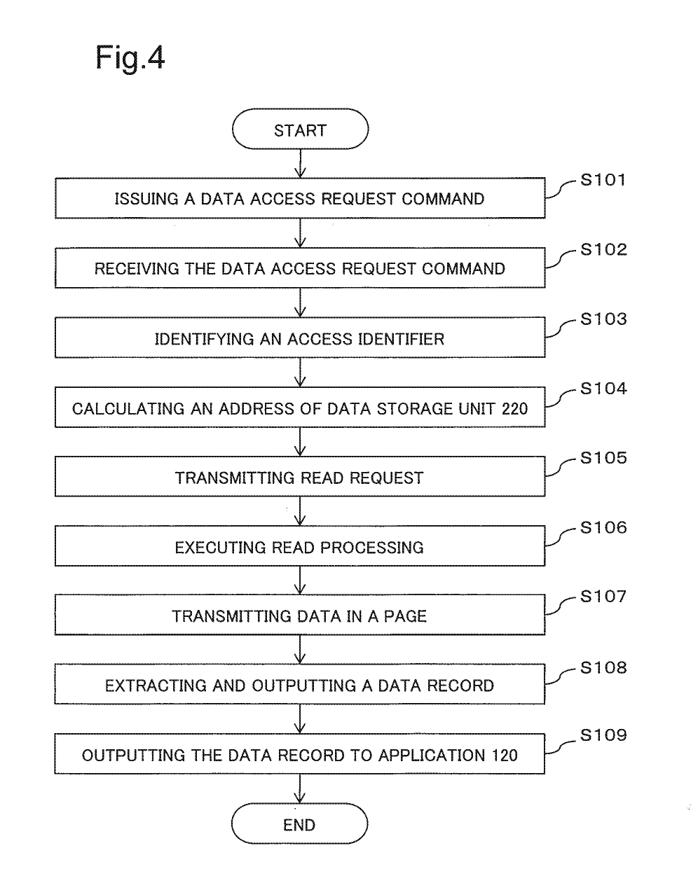

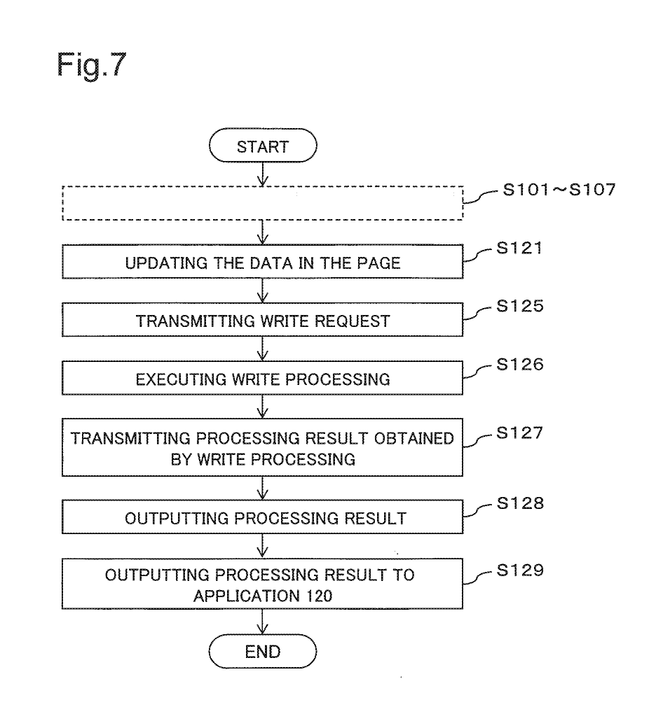

The CPU 701 causes an operating system (not illustrated) to operate to control the entire operation of the computer 700. The CPU 701 reads, for example, from the recording medium 707 mounted in the storage device 703, a program thereof or data and writes the read program or data on the storage unit 702. The program refers to a program for causing the computer 700 to execute, for example, operations of the calculator 100 in flowcharts illustrated in FIG. 4 and FIG. 7 to be described later.

The CPU 701 executes various types of processing as the access request reception unit 111, the address resolution unit 112, and the access execution unit 113 illustrated in FIG. 2, in accordance with the read program or on the basis of the read data.

The CPU 701 may download the program or the data on the storage unit 702 from an external computer (not illustrated) connected to a communication network (not illustrated).

The storage unit 702 stores the program or the data. The storage unit 702 may include a means that stores data received from the external storage device 200 and data to be transmitted to the external storage device 200.

The storage device 703 is, for example, an optical disk, a flexible disk, a magneto-optical disk, an external hard disk, or a semiconductor memory. The storage device 703 computer-readably stores the program. Further, the storage device 703 may store the data. The storage device 703 may include a means that stores data received from the external storage device 200 and data to be transmitted to the external storage device 200.

The input unit 704 receives an input of an operation by an operator or an input of information from the outside. A device used for an input operation is, for example, a mouse, a keyboard, a built-in key button, or a touch panel.

The output unit 705 is realized using, for example, a display. The output unit 705 is used to confirm an input request or an output, for example, by a GUI (GRAPHICAL User Interface).

The communication unit 706 realizes an interface with the network 300. The communication unit 706 is included as a part of the access execution unit 113.

As described above, the blocks as the function units of the calculator 100 illustrated in FIG. 2 are realized using the computer 700 having the hardware configuration illustrated in FIG. 3. However, the realization means of each unit included in the computer 700 is not limited to the above description. In other words, the computer 700 may be realized using one device physically coupled or may be realized by connecting two or more devices physically separated via wired channels or wireless channels and using a plurality of these devices.

When the recording medium 707 recording codes of the above-described program is supplied to the computer 700, the CPU 701 may read the codes of the program stored on the recording medium 707 and thereby execute the program. Alternatively, the CPU 701 may store the codes of the program stored on the recording medium 707 on the storage unit 702, the storage device 703, or both thereof. In other words, the present exemplary embodiment includes an exemplary embodiment of the recording medium 707 that transitorily or non-transitorily stores the program (software) executed by the computer 700 (CPU 701). A storage medium that non-transitorily stores information is referred to also as a non-volatile storage medium.

The above is description on the components as the hardware units of the computer 700 that realizes the calculator 100 in the present exemplary embodiment.

Next, operations of the present exemplary embodiment will be described in detail with reference to the drawings.

FIG. 4 and FIG. 7 to be described later are flowcharts illustrating operations of the calculator 100 and the external storage device 200 of the present exemplary embodiment. Processing of the calculator 100 based on the flowcharts may be executed on the basis of the above-described program control by the CPU 701. Further, a step name of the processing will be described with signs such as S101.

It is assumed that the data store is Key Value Store. FIG. 4 illustrates an example in which a data access request command (Read request) for reading first data corresponding to one Key is processed. Further, FIG. 7 illustrates an example in which a data access request command (Update request or put request) for registering/updating any first data corresponding to one Key is processed. Even for a case such as SQL processing for a relational database, it is apparent that the processing is substantially the same and is realizable with a slight modification.

To avoid complicated description, any response to error processing or the like will not be described. When the present exemplary embodiment is carried out, exceptional processing for physical/logical failures or mistakes in use of a user application may be added to the flowcharts illustrated in FIG. 4 and FIG. 7.

Further, when a plurality of calculators 100 share the external storage device 200 and the same record is updated among the plurality of calculators 100, exclusive control processing may be introduced in the present exemplary embodiment. Further, there is a case in which processing is concurrently executed even in one calculator 100 to exhibit high throughput performance, and also in such a case, exclusive control processing may be introduced in the present exemplary embodiment.

===Read Request Processing===

As illustrated in FIG. 4, the application 120 using data store software issues a data access request command (herein, a Read request) to the data store function realization unit 110 (step S101).

Specifically, the application 120 may call an API (Application Programming Interface) provided by the data store function realization unit 110 and thereby issue a data access request command thereof.

Further, the application 120 may communicate using an optional protocol such as http (hypertext transfer protocol), JSON (JavaScript (a registered trademark) Object Notation), or the like to thereby issues a data access request command thereof. In this case, the access request reception unit 111 may operate as a server corresponding to the protocol.

Regardless of these examples, the data access request command may be issued from the application 120 to the data store function realization unit 110 using an optional method.

The access request reception unit 111 of the data store function realization unit 110 receives the issued data access request command (step S102).

The address resolution unit 112 identifies an identifier (hereinafter, referred to as an access identifier) for identifying first data to be accessed described in the data access request command received by the access request reception unit 111 (step S103).

Herein, the access identifier is a Key in Key Value Store. In the case of Key Value Store, as an API provided by the data store function realization unit 110, for example, a get command is prepared. The get command refers to a get command in which “Key 1” such as “get(Key1)” upon acquiring a record corresponding to a Key is an argument. In this case, the argument information “Key 1” is an access identifier indicating access target data (Value). The address resolution unit 112 may correspond to various subspecies of the get command without limitation to the above description.

Further, when the data store is a relational database and the data access request command is an SQL command, the address resolution unit 112 may include a mechanism for interpreting the SQL command and converting the interpreted command to an execution command in access target data or a database. The mechanism may be, for example, a part of a query parser or a query optimizer.

In the case of the relational database, the access identifier includes, for example, information (e.g. a table name specified by a SELECT statement) indicating a table and a record ID (e.g. a value of an ID field specified by the SELECT statement). The access identifier may depend on the mounting of a relational database, regardless of the example.

The address resolution unit 112 calculates an address of the data storage unit 220 of the external storage device 200 from the identified identifier (step S104).

A calculation method for the address will be described in detail with reference to a corresponding drawing.

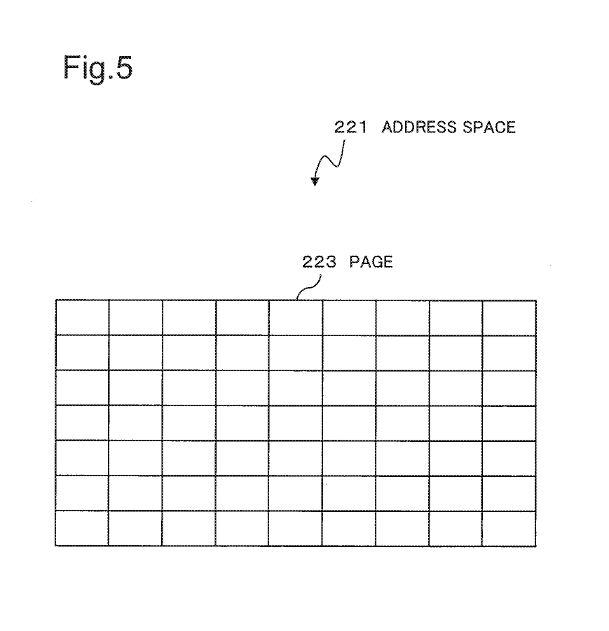

FIG. 5 is a diagram illustrating one example of an address space 221 of the data storage unit 220. In general, when a logical or physical address is specified, it is possible to identify an address destination of a storage medium included in the data storage unit 220.

The address space 221 illustrated in FIG. 5 is, for example, the whole or a part of a storage area of the data storage unit 220. The reason for a part of the storage area is that, for example, the storage area is used by being divided for a plurality of services or is ensured for an area that stores management information for system realization. The address space 221 is used as a storage destination of first data (i.e. second data including the first data).

In the present exemplary embodiment, the address space 221 of the data storage unit 220 is divided into pages with an optional size (pages 223 illustrated in FIG. 5). The access processing unit 210 accesses the address space 221 using an ID (IDENTIFIER) corresponding to each of the pages 223.

IDs (hereinafter, referred to as page IDs) are provided for respective pages using continuous numerical values in which, for example, toward the right from the left end of each row and toward a lower row from an upper row, the start is “0” and an increase is made by “1” each. For example, a page ID of a page 223 of the uppermost row and the leftmost end is “0,” a page ID of a page 223 of the uppermost row and the fifth from the left is “4,” and a page ID of a page 223 of the second row from the top and the fourth from the left is “12.”

A physical address corresponding to a page ID is uniquely calculable on the basis of a first address of the address space 221, a page ID, and a page size (e.g. a capacity of a page 223 indicated using a byte number). In other words, to calculate an address of the data storage unit 220, the calculator 100 may hold a first address of the address space 221, a page ID, and information of a page size. It is desirable for the address space 221 to ensure continuous pages, but the address space 221 may include discontinuous pages 223. In this case, the calculator 100 may hold a page ID of a first page 223 in continuous pages 223 and a start address.

The address resolution unit 112 identifies a page ID (i.e. a page 223) of an access destination on the basis of an access identifier, as described below.

Firstly, the address resolution unit 112 converts an access identifier (e.g. a Key value) identified in step S103 to a numerical value. The address resolution unit 112 converts a Key value to a numerical value using, for example, a common hash function (md5 or the like). The address resolution unit 112 may use a conversion function to a numerical value based on an optional mathematical equation and software of a processing program therefor.

Secondly, the address resolution unit 112 divides the value (hash value) obtained by the conversion by a total page number of the address space 221 and designates the residue as a page ID. The total page number is calculable by dividing a capacity of the address space 221 by a page size.

Thirdly, the address resolution unit 112 executes an operation of page ID×page size+start address on the basis of the calculated page ID and thereby calculates an address indicating a page 223 corresponding to the access identifier (Key value).

Inclusion of the above-described address resolution unit 112 makes it possible for the calculator 100 to access a page 223 corresponding to an access identifier by only holding the following information. The information includes a start address of the address space 221 of the external storage device 200, a hash function, and information indicating a page size and a size of the address space 221. However, this does not apply to a case of using up a capacity in a page 223. The case of using up the capacity in the page 223 will be described later.

The information indicating a page size and a size of the address space 221 may be a page size and a size of the address space 221 themselves. Further, the information indicating a page size and a size of the address space 221 may be a total page number of the address space 221 and a page size. The information indicating a page size and a size of the address space 221 may be a total page number of the address space 221 and a total capacity of the address space 221.

In the case of Key Value Store of the present exemplary embodiment, the calculator 100 can access a page 223 storing a Key value (access identifier) on the basis of the information. Further, these pieces of information are basically unchanged, from system initiation (during a failure, or against addition or deletion of an external storage device 200 upon operating a plurality of external storage devices 200). Therefore, even when, for example, a plurality of calculators 100 share the external storage device 200, the external storage device 200 can be shared by merely sharing the information among the calculators 100.

In other words, it is unnecessary to exchange information among the calculators 100 for sharing the external storage device 200, and it is possible to speed up processing in the data store function realization unit 110.

The above is description of the calculation method for the address.

Returning to FIG. 4, the access execution unit 113 then specifies the address calculated in step S104 and a data length of a page size and transmits a Read request (data access request) to the external storage device 200 (step S105).

The access processing unit 210 of the external storage device 200 receives the Read request and executes Read processing for the data storage unit 220 (step S106).

The access processing unit 210 transmits a processing result (herein, Read data, i.e. data (second data) in a page 223) obtained by the Read processing to the access execution unit 113 (step S107).

The access execution unit 113 extracts a data record (first data) identified by the access identifier extracted by the address resolution unit 112 from the received Read data (the data in the page 223). Then, the access execution unit 113 outputs the extracted data record to the access request reception unit 111 (step S108).

A method for extracting the data record (herein, a Value in Key Value Store) corresponding to the access identifier from the Read data will be described.

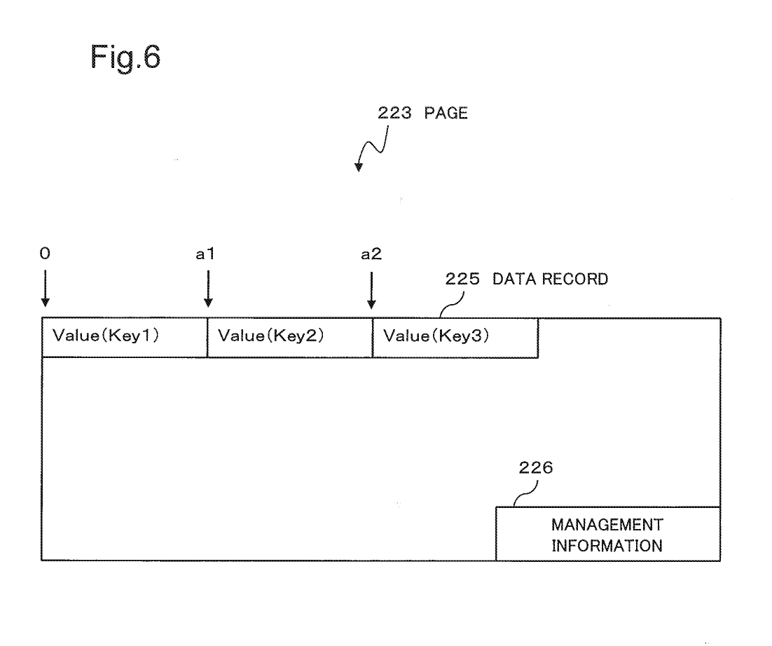

FIG. 6 is a diagram illustrating one example of a structure of a page 223. As illustrated in FIG. 6, the page 223 includes a data record 225 and management information 226.

The data record 225 is data of a “Value” corresponding to “Key 3.”

The management information 226 includes information of a “Key” stored in a page 223 and a pointer indicating a location in the page 223 storing a “value” corresponding to the Key. In other words, the management information 226 includes an access identifier corresponding to first data included in second data and a pointer indicating a location in a page 223 of the first data.

In FIG. 6, the management information 226 is stored on the tail side in a page 223. The management information 226 may be stored in an optional predetermined location without limitation to the tail side of the page 223.

When, as illustrated in FIG. 6, values corresponding to “Key 1,” “Key 2,” and “Key 3,” respectively, are stored in a page 223, the management information 226 includes, for example, the following information. The information is “Key 1:0:xx, Key 2:a1:yy, Key 3:a2:zz.” The fact that “data records 225 corresponding to “Key 1,” “Key 2,” and “Key 3” are stored in the page 223” means that page IDs determined on the basis of respective hash values of “Key 1,” “Key 2,” and “Key 3” are the same.”

In other words, the management information 226 includes “Key value: pointer:record size (bytes)” for each Key.

When, for example, the access execution unit 113 accesses a value of Key 2, the access execution unit 113 first acquires a pointer “a1” of Key 2 from the management information 226. The access execution unit 113 executes an access (e.g. read) for data of yy bytes from a location of “a1.”

The above-described management information 226 represents an example of management information in which the data record 225 is variable-length. When a record size is fixed (the data record 225 is fixed-length) as a system, information of the record size is unnecessary, and therefore, a capacity for the management information is reduced.

In step S108, until finding information corresponding to a searching Key, it is necessary for the access execution unit 113 to read the entire management information 226 in some cases. When the access execution unit 113 retrieves only information corresponding to approximately one data record 225 in the page 223, a simple configuration as in the management information 226 is employable. Further, the structure of the management information may be a structure (e.g. a structure in which sorting is executed in ascending order/descending order of Key values or an index structure) in which a Key value is more easily retrieved, without limitation to the example of the management information 226.

In the present exemplary embodiment, the access execution unit 113 receives data (second data) of a page unit from the external storage device 200. The access execution unit 113 executes processing for picking up a desired data record (first data, e.g. a value) 225 from the page 223 using a memory (e.g. the storage unit 702 illustrated in FIG. 3) on the calculator 100. For example, the access execution unit 113 acquires data in the page 223, copies the acquired data onto the storage unit 702 on the calculator 100, scans the management information 226 stored on the storage unit 702, and accesses the data record 225 stored on the storage unit 702.

The above is description of the method for extracting a data record 225 corresponding to an access identifier.

Returning to FIG. 4, the access request reception unit 111 then outputs, as a response to the Read request, the acquired data record 225 to the application 120 of a request source (step S109).

===Write Processing===

In the case of a data access request command (an Update request or a put request) of a Write system, the calculator 100 first acquires data in a page 223. The calculator 100 updates the data, for example, on the storage unit 702. Then, the calculator 100 executes Write processing of a page unit for the updated data.

Therefore, in FIG. 7, operations from step S101 to step S107 are the same as operations from step S101 to step S107 illustrated in FIG. 4.

The access execution unit 113 confirms whether there is a Key (access identifier) for identifying a data record 225 to be accessed in the management information 226. When the “Key” exists, the access execution unit 113 acquires a pointer to a “Value” corresponding to the “Key” in the same manner as processing in step S108 illustrated in FIG. 4. The access execution unit 113 updates the data (a “value” of second data and the management information 226) in the page 223 on the basis of the pointer and the data access request command (step S121).

When Value sizes (record sizes) are different before and after update, the access execution unit 113 may write a Value after update in a location different from that of a Value before update. Further, a case in which when the data record 225 is updated or deleted, a large number of free areas of unavailable sizes are generated in the page 223 may be conceived. In such a case, the calculator 100 may execute processing equivalent to garbage collection.

An operation of the access execution unit 113 in step S121 differs depending on a specification as the data store function realization unit 110.

It is assumed that, for example, the data store function realization unit 110 includes an API that adds a “value” corresponding to a “Key” using a put (Key, value) function. In this case, when there is already a data record 225 corresponding to the Key on the data storage unit 220, for example, the following two specifications are conceivable. One is a specification that updates the value. The other is a specification that issues a response in which “a Key already exists” to the application 120 and does not update the value. Specification development of the data store function realization unit 110 determines how these specifications are mounted. For example, in the latter specification, the data store function realization unit 110 executes an operation in which the “value” is not rewritten and a response is made to the application 120.

The access execution unit 113 specifies the updated data in the page 223 and the address calculated in step S104 and transmits a Write request (data access request) to the external storage device 200 (step S125).

The access processing unit 210 of the external storage device 200 receives the Write request and executes Write processing for the data storage unit 220 (step S126).

The access processing unit 210 transmits a processing result (herein, result information that is Write success or failure) obtained by the Write processing to the access execution unit 113 (step S127).

The access execution unit 113 outputs the received processing result to the access request reception unit 111 (step S128).

The access request reception unit 111 outputs the acquired processing result to the application 120 of a request source as a response to the Write request (step S129).

The above is description of the operations of the present exemplary embodiment.

Next, examples corresponding to a difference in a system configuration and peculiar cases in the present exemplary embodiment will be described.

===Partial Write===

In Write processing, there are cases in which only a partial update is necessary and an access of a page unit is unnecessary. When, for example, one calculator 100 exclusively occupies the external storage device 200 and the calculator 100 executes exclusive control of the inside, an area in a page 223 where data are necessary to be written is only a portion which is to be updated. Therefore, when it is unnecessary to update the management information 226, only data that are a target of the Write processing may be rewritten.

In this case, the access execution unit 113 skips processing of step S121 and rewrites only a target portion of a data record 225 in step S125 and step S126. Because the access execution unit 113 operates in such a manner, a performance of Write processing in the data store function realization unit 110 can be improved.

Further, also when a plurality of calculators 100 share one certain external storage device 200, the data store function realization unit 110 may perform an exclusive procedure in a page unit among the plurality of calculators 100 and execute write processing for only a portion which is to be updated. The portion which is to be updated is an update-targeted data record 225.

Further, it is possible that a function (e.g. a mechanism capable of executing a plurality of commands in an Atomic manner) of the external storage device 200 realizes exclusive control and the data store function realization unit 110 executes partial write processing as described above.

===Processing in which Data Overflows from Page 223===

It is conceivable that, for example, when new data (data (e.g. a Value) corresponding to a new access identifier (e.g. a Key)) are added, a page capacity of the data storage unit 220 of the external storage device 200 becomes insufficient. The page capacity refers to a capacity of a page indicated by a page size. In other words, there will be an increasing number of cases where with an increase in a size of the data record 225, data records 225 in which page IDs compete against each other are not held within one page 223.

Therefore, it is desirable to consider a size of data corresponding to an access identifier and allow a page size to be a size suitable for the size of data. The size of data corresponding to an access identifier differs depending on the application 120 using the data store function realization unit 110. Therefore, the page size may be previously set so as to be matched with a suitability of an application to be used.

In an assumption in which a hash function to be used, a page size corresponding to a record size, and a total page number are appropriate, each page 223 is substantially evenly used. Therefore, it is conceivable that when a capacity of the page 223 is insufficient, the entire storage capacity itself is also insufficient.

However, when the assumption breaks down or records to be stored on a specific page 223 are accidentally concentrated, a capacity of the specific page 223 becomes insufficient while there is room in a storage capacity in the entire information processing system 10.

In this case, the data store function realization unit 110 may store data on another page 223 different from a page 223 specified by a page ID calculated from an access identifier.

The access execution unit 113 first acquires, for example, a page 223 (a first page 223) specified by a page ID calculated on the basis of an access identifier.

The access execution unit 113 determines whether the management information 226 in the acquired first page 223 includes a value of the access identifier.

When the value of the access identifier is included, the access execution unit 113 executes processing on the basis of information corresponding to the access identifier.

When the value of the access identifier is not included, the access execution unit 113 acquires another page 223 (a second page 223) and executes processing. In doing so, the access execution unit 113 stores an access identifier and information of a page ID of the second page 223 where data are actually stored in the management information 226 in the first page 223.

A timing when the access execution unit 113 detects a deficiency of a page capacity refers to a timing when the access execution unit 113 newly stores a data record 225 on a page 223 or updates an existing data record 225. As a method for selecting a page 223 to be a storage destination of an overflowed data record 225 upon detecting a deficiency of a page capacity, a plurality of methods are conceivable.

In the data storage unit 220, for example, an extra page 223 is prepared in a storage area different from a first address space 221. The access execution unit 113 adds an overflowed record on the extra page 223.

Further, the access execution unit 113 may select another page 223 using an optional method (e.g. in a random manner).

Further, various methods for storing which record in a first page 223 on a second page 223 are conceivable.

The access execution unit 113 stores, for example, one having a large record size on the second page 223. Further, the access execution unit 113 may store a record (e.g. management information includes an update count value) having low update frequency in a second record.

Confirmation on whether there is a record of a specific access identifier is executed in various applications. Therefore, the access execution unit 113 may store information corresponding to an access identifier by which the same page 223 is calculated in the management information 226 of a page 223 (i.e. a page 223 calculated from the access identifier) to be an access destination first.

Such a configuration makes it possible for the access execution unit 113 to determine whether there is a data record 225 of the specific access identifier via a single access to the external storage device 200.

===Cache===

The access execution unit 113 may cache data in a page 223 using the storage unit 702 mounted in the calculator 100. By doing so, a performance of the data store function realization unit 110 is improved. When one calculator 100 exclusively uses the address space 221 of a specific external storage device 200, it is unnecessary for the one calculator 100 to consider that data on the external storage device 200 are updated from another calculator 100. Therefore, the access execution unit 113 may respond on the basis of a content of cache data during processing for a Read request. Thereby, a round-trip delay is reduced.

In Write processing, when the following two conditions are satisfied, the access execution unit 113 may return a response to the application 120 at the time of writing data onto a page 223 on the cache. The first condition is that one calculator 100 exclusively uses the address space 221 of a specific external storage device 200. The second condition is that a means that guarantees persistence of data does not store data on the external storage device 200.

However, when data on the external storage device 200 are used as the latest data, it is necessary to synchronously execute writing onto all pages 223 that are original or copied. Such synchronous writing processing makes it possible to restore a data store system, at the time of a failure of a certain calculator 100, by adding another calculator 100. In other words, when failure resistance is emphasized, an operation needs to be executed as described above.

Further, when a plurality of calculators 100 share the external storage device 200, update processing for a page 223 may occur from another calculator 100. Therefore, it is difficult to use a Read cache. Then, using the application 120 side or a load balancer, the calculator 100 that causes update processing to operate is allocated evenly to each access identifier. In this case, the access execution unit 113 may use a Read cache. In this case, even when the access execution unit 113 uses the Read cache, no mismatch occurs.

===Exclusive Control Among a Plurality of Calculators 100===

When there are a plurality of calculators 100 as illustrated in FIG. 1, exclusive control of a Write access to the same page 223 is executed. The calculator 100 may realize the exclusive control by employing a method such as a two-phase commit between the calculator 100 and another calculator 100.

Further, it is possible that on the external storage device 200, a plurality of processings are executed in an Atomic manner to realize exclusive control. In this case, no communication between calculators 100 is necessary. The external storage device 200 stores, for example, a version number for each access identifier in management information. The external storage device 200 refers to the version information and confirms whether a data record 225 corresponding to the access identifier has already been changed. When not having been changed already, the data record 225 is updated by the external storage device 200.

===A Plurality of Storage Devices===

When a plurality of external storage devices 200 are prepared and accesses to the external storage devices 200 are distributed, a performance of a data store system can be scaled up.

In this case, for example, different page IDs may be provided for the external storage devices 200, respectively. For example, pages IDs of 0 to 1000 may be provided for a first external storage device 200, and page IDs of 1001 to 2000 may be provided for a second external storage device 200. These pieces of information are shared among the calculators 100.

Further, the access execution unit 113 may determine which one of the external storage devices 200 is used using a method such as consistent hashing at the time of calculating a hash value. Then, the access execution unit 113 may determine which one of the page IDs in the external storage device 200 is used.

===Duplicate===

To ensure reliability, a duplicate of a page 223 can be generated.

When, for example, determining an external storage device 200 as a storage destination using a method such as consistent hashing, the access execution unit 113 selects a necessary number of nodes adjacent to a hash ring of consistent hashing. In this manner, the access execution unit 113 selects a plurality of external storage devices 200. Such a method is used as an existing technique, and therefore, detailed description will be omitted.

A first effect in the above-described present exemplary embodiment is that it is possible to improve response performances of the external storage device 200 and a storage system accessed via the network 300.

The reason is that the following configuration is included. In other words, firstly, the address resolution unit 112 calculates an address on the data storage unit 220 on the basis of an access identifier. Secondly, the access execution unit 113 interprets the management information 226 included in a page 223 read on the basis of the address and thereby acquires data corresponding to the access identifier.

In other words, the reason is that a number of times of commands from the calculator 100 to the external storage device 200 was reduced in order to reduce a communication delay.

A second effect in the above-described present exemplary embodiment is that it is possible to reduce communication among a plurality of calculators 100.

The reason is that the address resolution unit 112 calculates an address on the data storage unit 220 on the basis of a start address of the address space 221, a hash function, and information indicating a page size and a size of the address space 221 that are rarely subject to change.

A third effect in the above-described present exemplary embodiment is that it is possible to improve a performance of Write processing in the data store function realization unit 110.

The reason is that when it is unnecessary to execute an access of a page unit in Write processing, the access execution unit 113 rewrites only a target portion of a data record 225.

A fourth effect in the above-described present exemplary embodiment is that even in the following case, it is possible for the access execution unit 113 to determine whether there is a data record 225 of a specific access identifier via a single access to the external storage device 200. This case refers to a case in which data are stored on another page 223 different from a page 223 specified by a page ID calculated from the specific access identifier.

The reason is that the access execution unit 113 stores information corresponding to an access identifier by which the same page 223 is calculated in the management information 226 in a page 223 to be an access destination first.

A fifth effect in the above-described present exemplary embodiment is that it is possible to further improve a performance of the data store function realization unit 110.

The reason is that the access execution unit 113 cashes data in a page 223 using the storage unit 702 mounted in the calculator 100.

A sixth effect in the above-described present exemplary embodiment is that it is possible to improve a reliability of a data store provided by the information processing system 10.

The reason is that when determining an external storage device 200 as a storage destination using a method such as consistent hashing, the access execution unit 113 selects a necessary number of nodes adjacent to a hash ring of consistent hashing.

### Second Exemplary Embodiment

Next, a second exemplary embodiment of the present invention will be described in detail with reference to the corresponding drawing. Hereinafter, description of contents overlapped with the above description will be omitted in a range where description of the present exemplary embodiment is not unclear.

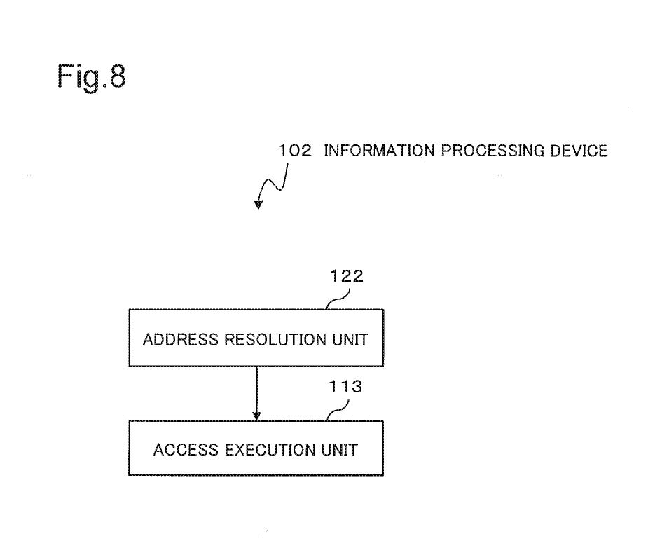

FIG. 8 is a block diagram illustrating a configuration of an information processing device 102 according to the second exemplary embodiment of the present invention.

As illustrated in FIG. 8, the information processing device 102 in the present exemplary embodiment includes an address resolution unit 122 and an access execution unit 113.

The address resolution unit 122 calculates an address for specifying a page 223 on a storage device on the basis of an access identifier that specifies data to be accessed. The page 223 stores data (first data) specified by the access identifier.

The access execution unit 113 is the same as the access execution unit 113 illustrated in FIG. 2.

A hardware configuration of the information processing device 102 is the same as the computer 700 illustrated in FIG. 3.

An effect in the above-described present exemplary embodiment is that it is possible to improve a response performance of the external storage device 200 and a storage system accessed via the network 300.

The reason is that the following configuration is included. In other words, firstly, the address resolution unit 122 calculates an address on the data storage unit 220 on the basis of an access identifier. Secondly, the access execution unit 113 interprets the management information 226 included in a page 223 read on the basis of the address and thereby acquires data specified by the access identifier.

In other words, the reason is that a number of times of commands from the calculator 100 to the external storage device 200 was reduced in order to reduce a communication delay.

The components described in the above-described exemplary embodiments do not necessarily exist independently of each other. For example, a plurality of optional components may be realized as one module. Further, any optional one of the components may be realized using a plurality of modules. Further, any optional one of the components may be another optional one of the components. Further, a part of any optional one of the components may be overlapped with a part of another optional one of the components.

The components and a module that realizes the components in the above-described exemplary embodiments may be realized, as necessary, in a hardware-like manner, if possible. Further, the components and a module that realizes the components may be realized using a computer and a program. Further, the components and a module that realizes the components may be realized by mixing a hardware-like module, a computer, and a program.

The program is recorded on a computer-readable, non-transitory recording medium such as a magnetic disk, a semiconductor memory, or the like and provided for a computer. The program is read by the computer from the non-transitory recording medium at the time of starting up the computer. The read program controls operations of the computer and thereby causes the computer to function as the components in the above-described exemplary embodiments.

In the above-described exemplary embodiments, a plurality of operations are sequentially described in a flowchart form, but an order of the description does not limit an order of executing the plurality of operations. Therefore, when the exemplary embodiments are carried out, the order of the plurality of operations may be modified without an obstacle in a content.

Further, in the above-described exemplary embodiments, a plurality of operations are not limited to executions at timings different from each other. For example, during execution of a certain operation, another operation may occur. Further, execution timings of a certain operation and another operation may be overlapped partially or as a whole.

Further, in the above-described exemplary embodiments, description is made in such a manner that a certain operation becomes a trigger for another operation, but the description does not limit all relations between the certain operation and the another operation. Therefore, when the exemplary embodiments are carried out, the relation between the plurality of operations can be modified without an obstacle in a content. Further, specific description of the operations of the components does not limit the operations of the components. Therefore, specific operations of the components may be modified without an obstacle to functional characteristics, performance characteristics, and other characteristics upon carrying out the exemplary embodiments.

A part or the whole of the exemplary embodiments can be described as the following supplementary notes, but the present invention is not limited to the following.

(Supplementary Note 1) An information processing device including: an address resolution unit that calculates an address identifying an area, based on an access identifier specifying data to be accessed, the area being in a storage device that stores a first data specified by the access identifier; and an access execution unit that acquires the first data included in second data, based on management information included in the second data being in the area read based on the calculated address, and executes an operation of the first data on the second data.

(Supplementary Note 2) The information processing device according to Supplementary Note 1, wherein when executing a data operation that is any one of addition, deletion, and update of the first data, the access execution unit acquires the second data based on the access identifier in relation to the first data from the storage device, executes the data operation on the acquired second data, and writes the second data on which the data operation is executed in the storage device.

(Supplementary Note 3) The information processing device according to Supplementary Note 1 or 2, wherein

the address resolution unit calculates a numerical value corresponding to the access identifier, and

calculates the address based on the calculated numerical value, a start address of an available address space on the storage device, and information indicating a size of the area and a size of the address space.

(Supplementary Note 4) The information processing device according to Supplementary Note 3, wherein the address resolution unit calculates a hash value of the access identifier as the numerical value.

(Supplementary Note 5) The information processing device according to any one of Supplementary Notes 1 to 4, wherein the management information includes information indicating a correspondence between an access identifier in relation to the first data included in the second data and a pointer indicating a location in the area of the first data.

(Supplementary Note 6) The information processing device according to any one of Supplementary Notes 1 to 5, wherein the management information included in the area read based on the address calculated based on the access identifier in relation to the first data includes information indicating that the first data are stored in another area on the storage device and information indicating that the first data are stored in an area of another storage device.

(Supplementary Note 7) The information processing device according to any one of Supplementary Notes 1 to 6, wherein the address is a physical address on the storage device.

(Supplementary Note 8) The information processing system including: a storage device that stores first data corresponding to an access identifier specifying data to be accessed; and an information processing device including an address resolution unit that calculates an address identifying an area based on the access identifier and an access execution unit that acquires the first data included in second data based on management information included in the second data being in the area read based on the calculated address, and executes an operation of the first data on the second data.

(Supplementary Note 9) The information processing system according to Supplementary Note 8, wherein the access execution unit acquires the second data based on the access identifier corresponding to the first data from the storage device when executing a data operation that is any one of addition, deletion, and update of the first data, executes the data operation on the acquired second data, and writes the second data on which the data operation is executed in the storage device.

(Supplementary Note 10) The information processing system according to Supplementary Note 8 or 9, wherein

the address resolution unit calculates a numerical value corresponding to the access identifier, and

calculates the address based on the calculated numerical value, a start address of an available address space in the storage device, and information indicating a size of the area and a size of the address space.

(Supplementary Note 11) The information processing system according to Supplementary Note 10, wherein the address resolution unit calculates a hash value of the access identifier as the numerical value.

(Supplementary Note 12) The information processing system according to any one of Supplementary Notes 8 to 11, wherein the management information includes information indicating a correspondence between an access identifier corresponding to the first data included in the second data and a pointer indicating a location of the first data in the area.

(Supplementary Note 13) The information processing system according to any one of Supplementary Notes 8 to 12, wherein the management information included in the area read based on the address calculated based on the access identifier corresponding to the first data includes information indicating that the first data are stored in another area in the storage device and information indicating that the first data are stored in an area in another storage device.

(Supplementary Note 14) The information processing system according to any one of Supplementary Notes 8 to 13, wherein the address is a physical address in the storage device.

(Supplementary Note 15) A data access method including causing a computer to calculate an address identifying an area based on an access identifier specifying data to be accessed, the area being in a storage device that stores a first data corresponding to the access identifier;

acquire the first data included in second data based on management information included in the second data being in the area read based on the calculated address; and execute an operation of the first data on the second data.

(Supplementary Note 16) A program causing a computer to execute processing for calculating an address identifying an area based on the access identifier specifying data to be accessed, the area being in a storage device that stores a first data corresponding to the access identifier acquiring the first data included in second data based on management information included in the second data being in the area read based on the calculated address; and executing an operation of the first data on the second data.

(Supplementary Note 17) An information processing device including: a processor; and a storage unit that holds an command executed by the processor, the instruction causing the processor to operate as an address resolution means and an access execution means,

the address resolution means calculating an address identifying an area based on the access identifier specifying data to be accessed, the area being in a storage device that stores a first data corresponding to the access identifier acquiring the first data included in second data based on management information included in the second data being in the area read based on the calculated address; and executing an operation of the first data on the second data.

(Supplementary Note 18) A computer-readable, non-transitory recording medium recording a program that causes a computer to execute processing for calculating an address identifying an area based on the access identifier specifying data to be accessed, the area being in a storage device that stores a first data specified by the access identifier acquiring the first data included in second data based on management information included in the second data being in the area read based on the calculated address; and executing an operation of the first data on the second data.

While the present invention has been described with reference to exemplary embodiments thereof, the present invention is not limited to these exemplary embodiments. The constitution and details of the present invention can be subjected to various modifications which can be understood by those skilled in the art, without departing from the scope of the present invention.

This application is based upon and claims the benefit of priority from Japanese patent application No. 2014-020317, filed on Feb. 5, 2014, the disclosure of which is incorporated herein in its entirety.

### INDUSTRIAL APPLICABILITY

The present invention is applicable to a database system or a queue value store system using a storage device connected via a network and a shared-type distributed data store system in which a plurality of calculators share a common storage device.

### REFERENCE SIGNS LIST

10 Information processing system
100 Calculator
110 Data store function realization unit
111 Access request reception unit
112 Address resolution unit
113 Access execution unit
120 Application
200 External storage device
210 Access processing unit
220 Data storage unit
221 Address space
223 Page
225 Data record
226 Management information
300 Network
700 Computer
701 CPU
702 Storage unit
703 Storage device
704 Input unit
705 Output unit
706 Communication unit
707 Recording medium

What is claimed is:

1. An information processing device comprising:
address resolution unit configured to calculate an address identifying an area, based on an access identifier specifying data to be accessed, the area being in a storage device that stores a first data specified by the access identifier; and
access execution unit configured to acquire the first data included in second data, based on management information included in the second data being in the area read based on the calculated address, and execute an operation of the first data on the second data.

2. The information processing device according to claim 1, wherein,
when executing a data operation that is any one of addition, deletion, and update of the first data, the access execution unit
acquires the second data based on the access identifier in relation to the first data from the storage device, executes the data operation on the acquired second data, and writes the second data on which the data operation is executed in the storage device.

3. The information processing device according to claim 1, wherein
the address resolution unit
calculates a numerical value corresponding to the access identifier, and
calculates the address based on the calculated numerical value, a start address of an available address space in the storage device, and information indicating a size of the area and a size of the address space.

4. The information processing device according to claim 3, wherein
the address resolutions unit calculates a hash value of the access identifier as the numerical value.

5. The information processing device according to claim 1, wherein
the management information includes information indicating a correspondence between the access identifier in relation to the first data included in the second data and a pointer indicating a location of the first data in the area.

6. The information processing device according to claim 1, wherein
the management information included in an area read based on the address calculated based on the access identifier in relation to the first data, includes information indicating that the first data are stored in another area in the storage device and information indicating that the first data are stored in an area in another storage device.

7. The information processing device according to claim 1, wherein
the address is a physical address in the storage device.

8. An information processing system comprising:
the information processing device according to claim 1 and
the storage device.

9. A data access method causing a computer to:
calculate an address identifying an area, based on an access identifier specifying data to be accessed, the area being in a storage device that stores a first data specified by the access identifier;
acquire the first data included in second data, based on management information included in the second data being in the area read based on the calculated address; and
execute an operation of the first data on the second data.

10. A computer-readable non-transitory recording medium recording a program that causes a computer to execute processing of:
calculating an address identifying an area, based on an the access identifier specifying data to be accessed, the area being in a storage device that stores a first data specified by the access identifier;
acquiring the first data included in second data, based on management information included in the second data being in the area read based on the calculated address; and
executing an operation of the first data on the second data.
